(19) United States
(12) Patent Application Publication
(10) Pub. No.: US 2003/0229528 A1
(43) Pub. Date: Dec. 11, 2003

(54) Information distribution method and system

(76) Inventors: Atsunori Nitao, Tokyo (JP); Toshio Ichino, Tokyo (JP)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/424,833

(22) Filed: Apr. 29, 2003

(30) Foreign Application Priority Data
Apr. 30, 2002 (JP) JP2002-129205

(51) Int. Cl. G06F 17/60

(52) U.S. Cl. 705/7; 709/224

(57) ABSTRACT

Information including various kinds of information relating to a movable body such as automobiles, etc. is collected, modified and distributed in accordance with a request of an associating enterprise using the information. An information collection/modification/distribution apparatus collects information from various information providing apparatus, and performs processing such as data mining, with respect to the collected information. The information collection/modification/distribution apparatus distributes information including information such as an item of the information to be collected from the information providing apparatus, a time and a time range to collect and to distribute over a period of time in accordance with the request of an information user to an information using apparatus.

### BACKGROUND OF THE INVENTION

1. Field of the Invention

The present invention relates to an information distributing method and system for collecting and distributing information.

2. Description of the Related Art

As discussed in numerous web sites on the Internet, a service called telematics for providing information to an automobile is provided by a number of automobile manufacturers and the spread of telematics services is desired.

The cost of providing such telematics services are mainly borne by subscriber charges.

For example, JP-A-2000-123070 discloses a method of locating the position of a movable body and guiding it.

### SUMMARY OF THE INVENTION

An object of the present invention is to provide a new and improved method of and system for information distribution in which information relating to an apparatus, such as an automobile used by many subscribers, can be collected and distributed to an enterprise associated with this apparatus, and to an information service that can be provided to many subscribers.

Another object of the present invention is to provide a new and improved method of and system for information distribution to provide a service for collecting, modifying and distributing information useful for the enterprise from many subscribers even when the information service is provided at no cost to the subscribers.

To achieve the above objects, an information distributing method in accordance with an embodiment of the present invention collects and distributes information among one or more information distributors, one or more information users, and one or more information providers. Each information distributor collects information from the information provider and distributes the collected information to the information user. Each information user uses the distributed information and provides a predetermined service to the information providers. Each information provider provides predetermined information to the information distributor and utilizes the provided service.

The information distributor preferably provides the predetermined service instead of the information user.

The information distributor preferably charges the information user distributing the information.

The service provided by each information user is preferably free.

The information distributor preferably accelerates the providing of information to the information provider.

The information distributor preferably stores the collected information and performs batch processing with respect to the stored information.

Each information distributor preferably periodically distributes the information.

Each information distributor preferably collects the information only within a predetermined period of time, and distributes the collected information to each information user.

Each information distributor preferably collects the information over a period of time, and distributes the collected information over a period of time to each information user.

It is preferable that each information user assigns a distributing item, a distributing time, and a collecting time and time period to the information distributor, and each information distributor modifies the collected information in accordance with the assignment of each information user and distributes the modified information.

It is preferable that each information provider includes a predetermined apparatus, and each information distributor collects information outputted from the apparatus included in the information provider.

It is preferable that each information provider includes a predetermined apparatus, and each information distributor collects information showing an attribute of the apparatus included in the information provider, a state of the apparatus and an operation with respect to the apparatus.

It is preferable that each information provider includes an apparatus for detecting a position as the predetermined apparatus, and each information distributor collects information showing the position of each information provider over a period of time, and provides this information to each information user.

The information provider is preferably an automobile. It is preferable that the information user includes a new car dealer or a used car dealer, and each information provider includes an automobile, and each information distributor collects information showing a model, a driving distance, a past repair record and an driving area of the automobile, or a combination thereof, and provides the collected information to the new car dealer or the used car dealer.

In an information utilizing method in accordance with embodiment of the present invention for utilizing information distributed by the above-noted information distributing method, the information user is a traffic information service trader and obtains traffic information by using position information of each provided automobile over a period of time.

In the information utilizing method of utilizing information distributed by the above-noted information distributing method, it is preferable that the information distributor further collects the attribute of a driver of the automobile, and generates information showing a traffic volume for every area and attribute of the driver of the passing automobile on the basis of the provided position information of each information provider over a period of time, and provides such information to the information user, and the information user includes a retail trader, and the retail trader utilizes the provided information in a marketing plan.

In the information utilizing method of utilizing information distributed by the above-noted information distributing method, it is preferable that each information provider includes an automobile as the predetermined apparatus, and the information distributor collects information showing the past record of repairs, accidents and failures of each automobile, or a combination thereof, and provides this information to an insurance company, and the information user includes the insurance company, and the insurance company performs at least goods development or the calculation of insurance rates using the provided information.

In the information utilizing method of utilizing information distributed by the above-noted information distributing method, it is preferable that each information provider includes a voice/screen image apparatus operated by a user, and each information distributor collects information showing an operation of the user with respect to the voice/screen image apparatus, and provides this information to the information user, and the information user includes a broadcast station or a music company, and the broadcast station or the music company determines a preference of the user on the basis of the provided information showing the operation of each user with respect to the voice/screen image apparatus.

In the information utilizing method of utilizing information distributed by the above-noted information distributing method, it is preferable that each information provider includes an automobile as the predetermined apparatus, and the information distributor collects information showing the past record of repairs, accidents and failures of each automobile, or a combination thereof, automobile information including make and model, and information relating to a driver of the automobile, and provides this information to the information user, and the information user includes a load service company, and provides an improved rapid service using the information.

In the information utilizing method of utilizing information distributed by the information distributing method, it is preferable that each information provider includes an automobile as the predetermined apparatus, and the information distributor provides a past driving record of each automobile to the information user, and the information user includes a car rental or leasing agency of the automobile, and more accurately sets fees, maintenance and repayment period using the information.

The information distributing system in accordance with an embodiment of the present invention is connected to one or more information providing apparatus, one or more information distributing apparatus, and one or more information using apparatus. Each information distributing apparatus has an information collector for collecting information from the information providing apparatus and an information distributor for distributing the collected information to the apparatus. In addition, each apparatus has an information using apparatus for using the distributed information and a service provider for providing a predetermined service to each information providing apparatus. Each information providing apparatus has an information provider for providing predetermined information to the information collector and a service utilizer for utilizing the provided service.

An information distributing apparatus in accordance with an embodiment of the present invention is connected to one or more information providing apparatus and one or more information using apparatus. Each information using apparatus uses distributed information, and provides a predetermined service to each information providing apparatus. Each information providing apparatus provides predetermined information to an information collecting apparatus and utilizes the provided service. The information distributing apparatus comprises an information collector for collecting the information from the information providing apparatus and an information distributor for distributing the collected information to the information using apparatus.

The information using apparatus preferably further comprises a service provider for providing the predetermined service when the information using apparatus does not provide the predetermined service.

The information distributing apparatus preferably further comprises an accounting processor for charging the information using apparatus distributing the information.

The information distributing apparatus preferably further comprises an accelerator for accelerating the providing of information from the information providing apparatus.

The information distributing apparatus preferably further comprises an information storage device for storing the collected information and a batch processor for performing batch processing of the stored information.

It is preferable that each information using apparatus assigns an item of information to be distributed, a distributing time and collecting time and a time period to the information distributing apparatus. The information distributing apparatus further comprises an information modifier for modifying the collected information in accordance with the assignment of the distributed information and for distributing the modified information.

It is preferable that each information using apparatus assigns an item of the information to be distributed, a distributing time and collecting time and a time period to the information distributing apparatus. The information providing apparatus provides information in accordance with a collecting rule, and the information distributing apparatus further comprises a collecting rule generator/transmitter for generating a collecting rule for collecting the distributed information and for transmitting this rule to the information providing apparatus.

It is preferable that each information using apparatus assigns an item of information to be distributed, a distributing time and collecting time and a time period to the information distributing apparatus. The information distributing apparatus further comprises a collecting rule generator for generating a collecting rule for collecting the distributed information. The information collector collects the provided information in accordance with the generated collecting rule.

An information providing apparatus in accordance with embodiment of the present invention is connected to one or more information using apparatus and one or more information distributing apparatus. Each information distributing apparatus collects information from the information providing apparatus and distributes the collected information to the information using apparatus. Each information using apparatus uses the distributed information. Either the information using apparatus or the information distributing apparatus provides a predetermined service to each information providing apparatus. The information providing apparatus comprises an information provider for providing predetermined information to the information distributing apparatus and a service utilizer for utilizing the provided service.

It is preferable that each information using apparatus assigns the information to be distributed to the information distributing apparatus. The information distributing apparatus generates a collecting rule for collecting the information to be distributed and transmits the collecting rule to the information providing apparatus. The information provider receives the transmitted collecting rule and provides the information in accordance with the received collecting rule.

It is preferable that the information provider provides information as to the attributes of a predetermined apparatus, a state of the predetermined apparatus, an operation with respect to the predetermined apparatus and a past record of the predetermined operation, or a combination thereof.

An information using apparatus in accordance with an embodiment of the present invention is connected to one or more information providing apparatus and one or more information distributing apparatus. Each information distributing apparatus collects information from the information providing apparatus and distributes the collected information to the information using apparatus. Each information providing apparatus provides predetermined information to the information distributing apparatus and utilizes the provided service. The information using apparatus comprises an information user for using the distributed information, and a service provider for providing a predetermined service to each information providing apparatus.

It is preferable that the information distributing apparatus distributes information according to assignment from the information using apparatus. The information distributing apparatus further comprises an information assignor for assigning the distributed information to the information distributing apparatus.

A first program in accordance with an embodiment of the present invention in an information distributing system connected to one or more information providing apparatus, one or more information distributing apparatus and one or more information using apparatus effects processing by a computer. The computer of each information distributing apparatus executes processing for collecting information from the information providing apparatus and for distributing the collected information to the information using apparatus. The computer of each information using apparatus executes processing for using the distributed information and for providing a predetermined service to each information providing apparatus. The computer of the information providing apparatus executes processing for providing predetermined information to the information collector and for utilizing the service from the information using apparatus.

A second program in accordance with an embodiment of the present invention in an information distributing apparatus connected to one or more information providing apparatus and one or more information using apparatus effects processing by a computer. Each information using apparatus uses distributed information and provides a predetermined service to each information providing apparatus. Each information providing apparatus provides predetermined information to an information collecting apparatus and utilizes the provided service. The computer executes processing for collecting information from the information providing apparatus and for distributing the collected information to the information using apparatus.

A third program in accordance with an embodiment of the present invention in an information providing apparatus connected to one or more information using apparatus and one or more information distributing apparatus effects processing by a computer. Each information distributing apparatus collects information from the information providing apparatus and distributes the collected information to the information using apparatus. Each information using apparatus uses the distributed information and provides a predetermined service to each information providing apparatus. The computer executes processing for providing predetermined information to an information collecting apparatus and processing for utilizing the provided service.

A fourth program in accordance with an embodiment of the present invention in an information using apparatus connected to one or more information providing apparatus and one or more information distributing apparatus effects processing by a computer. Each information distributing apparatus collects information from the information providing apparatus and distributes the collected information to the information using apparatus. Each information providing apparatus provides predetermined information to an information collecting apparatus. The computer executes processing for utilizing a provided service and using the distributed information and for providing a predetermined service to each information providing apparatus.

### DESCRIPTION OF THE DRAWINGS

FIG. 1 is a diagram of an information collection/modification/distribution system for applying an information distributing method in accordance with an embodiment of the present invention.

FIG. 2 is a diagram for the flow of information in the information collection/modification/distribution system of FIG. 1.

FIG. 3 is a block diagram of a transceiver in an automotive vehicle of the system of FIG. 1.

FIG. 4 is a block diagram configuration of a server (an information using apparatus and an information collection/modification/distribution apparatus) of FIG. 3.

FIG. 5 is a diagram showing the configuration of an information provision/utilization program executed by the server of FIGS. 3 and 4.

FIG. 6 is a flow diagram of the operation (S10) of the information providing apparatus (the information provision/utilization program of FIG. 5) of FIG. 3 at its event generating time.

FIG. 7 is a diagram of an information using program executed by the information using apparatus of FIG. 1.

FIG. 8 is a diagram of an information collection/modification/distribution program executed by the information collection/modification/distribution apparatus of FIG. 1.

FIG. 9 is a diagram of the configuration of the database (DB) of FIG. 8.

FIG. 10 is a flow diagram of the operation (S12) of an information distributing section of the information collection/modification/distribution program of FIG. 8.

FIG. 11 is a flow diagram of batch processing (S14) of a data processing section of the DB of FIG. 9.

FIG. 12 is a diagram of a communication sequence between each information providing apparatus of FIG. 1 and the information collection/modification/distribution apparatus.

FIG. 13 is a diagram of a communication sequence between an information using apparatus 24 of FIG. 1 and the information collection/modification/distribution apparatus.

### DETAILED DESCRIPTION

Industries relating to automobiles include automobile part manufacturers, tire manufacturers, audio equipment manufacturers, the music industry, radio broadcast stations, new car dealers, used car dealers, as well as automobile manufacturers.

The traffic flow of automobiles has a great influence on retailing, e.g., marketing of existing products and locations of new shops.

In these industries, data and information such as the model and the year of an automobile, moving direction and path, moving speed, the behavior and preference of a user of the automobile, etc. are useful in planning an enterprise strategy, etc.

In the following description, “data” and “information” are collectively defined as “information” to prevent a misunderstanding caused by mixing “data” and the “information”.

A survey of automobile users has been used to collect such information.

However, since an answer to the survey depends on the memory of the user, there is a limit as to the kind of information obtained and its accuracy.

Namely, there is yet no decisive effective way of rapidly collecting the information useful for an enterprise relating to the automobile, in large quantities, accurately, and at a low cost.

On the other hand, as already described, there is a service called telematics for providing information to the automotive vehicle user.

A car mounted server for providing this service is connected to a control panel of the automobile, a display device, a car navigation device, etc. Therefore, if this server is used well, this server can be used to automatically collect information useful for the above automobile relating industries.

Accordingly, if such information can be collected by using the car mounted server, etc. under the understanding of the automobile user, it becomes a very effective information collecting method with respect to the automobile related industries, etc.

Further, this kind of information does not violate the privacy of the automobile user as long as this information is used only for statistical purposes.

Furthermore, when a utilization fee of the telematics service is discounted and is set to be free with respect to the automobile user agreeing to provide the information, it is beneficial to the automobile user and the number of telematics subscribers can be increased.

The present invention is not limited to telematics, the automobile and its related industries, but rather the explanations contained below are merely for exemplary purposes.

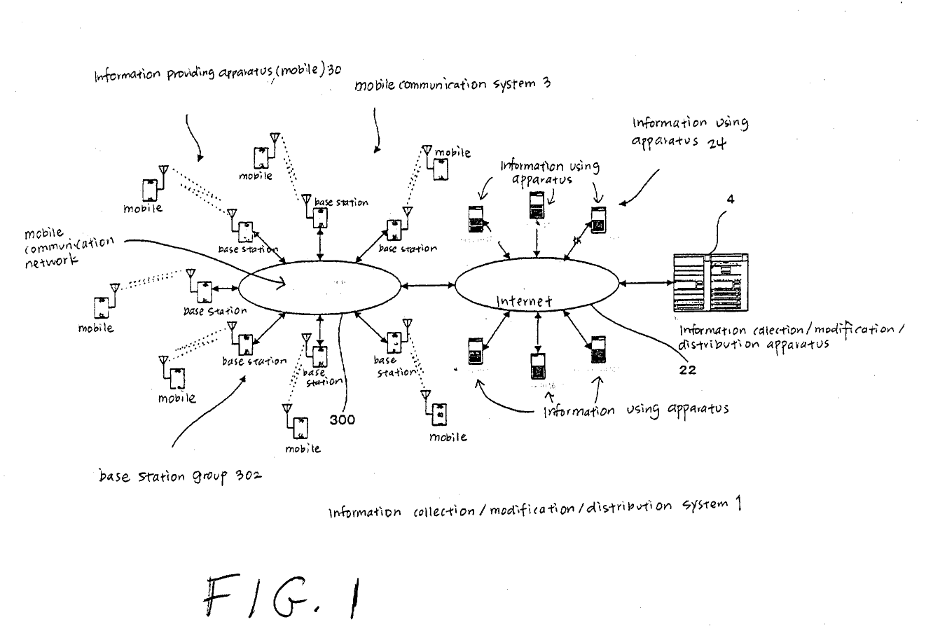

As shown in FIG. 1, the information collection/modification/distribution system 1 includes the Internet 22, one or more information using apparatus 24 each connected to the Internet 22, a mobile communication system 3 and an information collection/modification/distribution apparatus 4.

The mobile communication system 3 includes a mobile communication network 300, a base station group 302 including plural base stations connected to the mobile communication network 300, and one or more information providing apparatus 30 connected to the base station group 302 through a wireless communication line.

In the information collection/modification/distribution system 1, the information collection/modification/distribution apparatus 4 collects information relating to the information providing apparatus 30, distributes this information to the information using apparatus 24, and charges the information using apparatus 24. The information using apparatus 24 uses the distributed information and provides a service with respect to the information providing apparatus 30.

As shown in FIG. 2, in the information collection/modification/distribution system 1, users of the information providing apparatus 30 and the information using apparatus 24 first perform registration for subscription with respect to the information collection/modification/distribution apparatus 4.

The information collection/modification/distribution apparatus 4 collects information from many registered information providing apparatus 30, and performs modification (extraction, analysis, summary mart/data mart, mining, etc.) of the collected information on the basis of a request from the information using apparatus 24.

The summary mart/data mart includes processing for extracting data required in a specific section as a subset from a data warehouse storing all information of enterprises thereto, and its subset. The summary mart/data mart is a combination of a database and its analyzing and visualizing tool.

Such processing is effected by every section, such as a development section, a business section, an accounting section, etc. and the analyzation and the visualization are performed in accordance with a request of each section.

In the following description, the “summary mart” and the “data mart” are called a “summary mart”.

Furthermore, for example, when no information desired by the user of the information using apparatus 24 is collected, or when the number of users needing the information provided by the information using apparatus 24 is small, the information collection/modification/distribution apparatus 4 accelerates the information provision and subscription, etc. to the user of the information providing apparatus 30.

Such collected and modified information is distributed to the requested information using apparatus 24 at an assigned time interval.

The information using apparatus 24 provides various kinds of services to the information providing apparatus 30 at low cost or free of charge as compensation for the reception of the information provision.

The information collection/modification/distribution apparatus 4 can charge the information using apparatus 24 to obtain compensation for the information distribution to the information using apparatus 24.

The information provided from the information providing apparatus 30 to the information collection/modification/distribution apparatus 4 and the information using apparatus 24 can be configured by the attribute of an automobile (the make and year of the automobile, etc.), states of the automobile (engine speed/temperature, a driving distance, a manually inputted past repair record, a collision detected by a sensor, the information of a control system such as the state of an oil/brake warning, power steering, etc., the information of a body system such as an air conditioner, an air bag, a light, a seat belt, etc.), a position and a moving mode (a position, a moving speed, a moving path, a departure location, a destination, etc.), operations with respect to the automobile and its accessory devices (operations with respect to an automobile main body, GPS, car navigation apparatus, radio and audio devices, etc.), and other information (a subscribed insurance company), etc.

The above automobile related industries, the music industry, the broadcast station, the retail trade, an insurance company, etc. are considered to be users of the information using apparatus 24.

The construction and the operation of each portion of the information collection/modification/distribution system 1 of FIG. 1 is next described in detail.

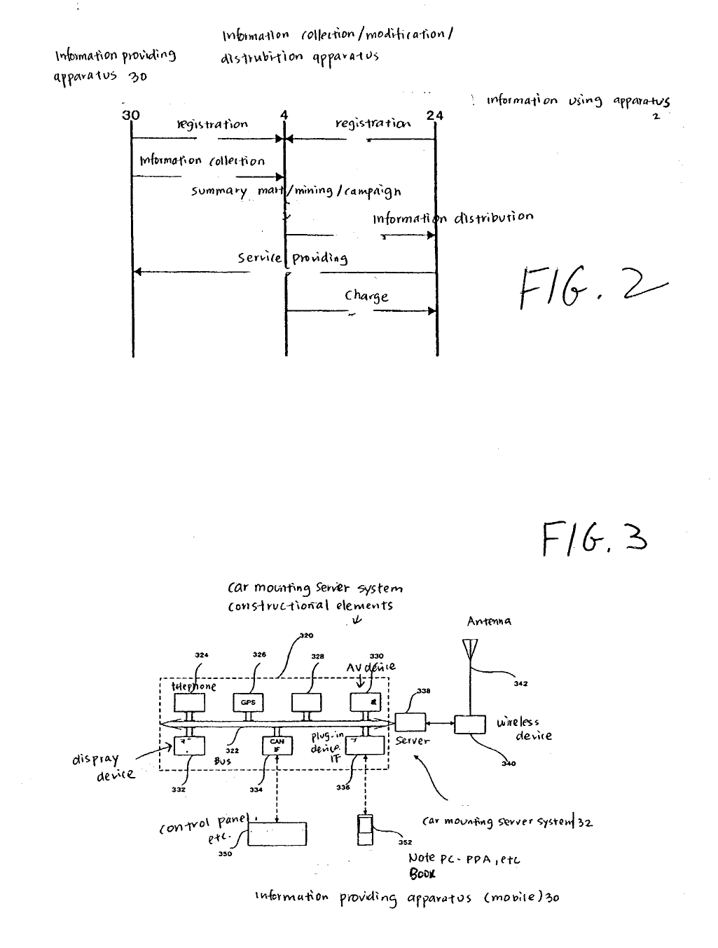

FIG. 3 shows the configuration of the information providing apparatus 30 of FIG. 1.

The information providing apparatus 30 includes an automotive vehicle (frequently referred to herein as “car” or “automobile”) mounted server system 32, an automobile portion 350 such as a control panel, etc., and a plug-in device 352 such as a PDA/notebook PC, etc. connected to the car mounted server system 32.

The car mounted server system 32 includes car mounted server system constructional elements 320, a server 338 and a wireless apparatus 340.

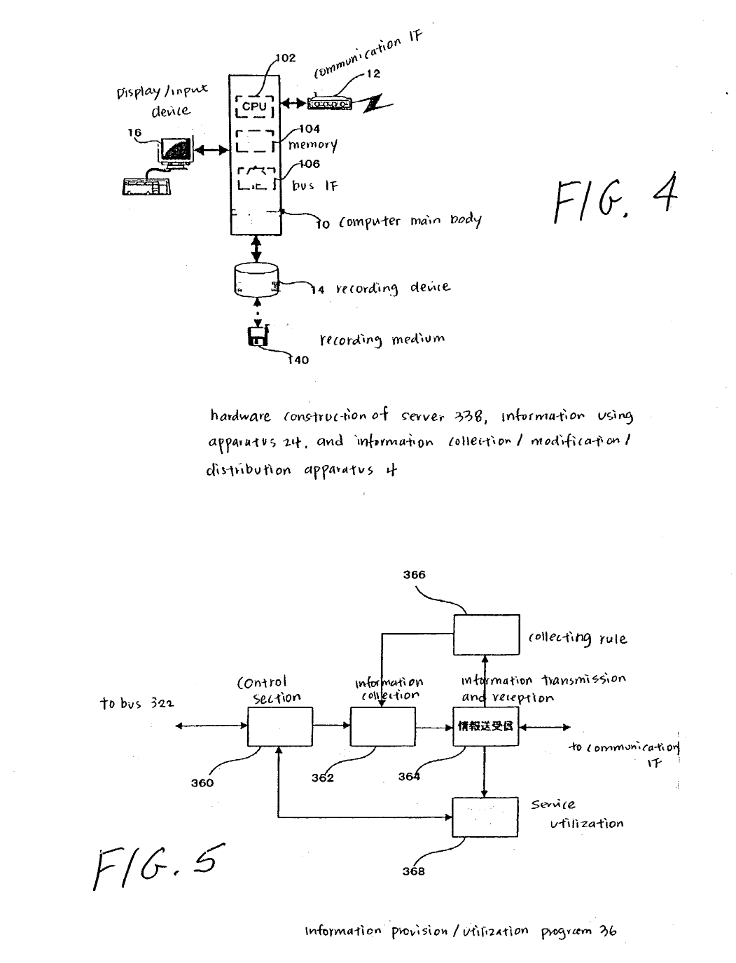

The car mounted server system constructional elements 320 include a telephone 324 connected through an infrared bus 322 (IrDA, BlueTooth, etc.), a GPS application apparatus 326 (a car navigation apparatus, etc.), a radio 328, an audio apparatus 330 (a CD player, an amplifier, etc.), a display/input apparatus 332 (capable of being used together with the display/input apparatus 16 of FIG. 4), a CAN (Controller Area Network) interface (CANIF) 334, a plug-in device IF 336, etc.

The wireless apparatus 340 gets access to a base station group 302 through an antenna 342 and a wireless communication line, and receives and transmits information through the mobile communication network 300 and the Internet 22 between the information using apparatus 24 and the information collection/modification/distribution apparatus 4.

Each car mounted server system constructional element 320 returns its processing information to the server 338 in accordance with a request of the server 338.

The telephone 324 of the car mounted server system constructional elements 320 outputs information such as the kind of telephone 324, etc. to the server 338.

The GPS application apparatus 326 outputs information such as the kind of GPS application apparatus 326, software used and map used, the position of the information providing apparatus 30, etc. to the server 338.

The radio 328 outputs information such as the kind of radio 328 and which radio station is selected by a user at which time, etc. to the server 338.

The audio apparatus 330 outputs information such as the kind of audio apparatus 330, the title of a CD listened to by the user, the number of performance times, etc. to the server 338.

The CANIF 334 is an interface for a high speed LAN within an automobile able to perform real time communication of about 1 Mbps at its maximum. For example, the CANIF 334 receives information such as the attributes of the automobile, such as a model, a manufacture date, a past repair record (manually set), a collision (detected by a sensor, etc.), etc. of the automobile, and information such as the state of the automobile such as an driving speed, an driving distance, an engine temperature, the state of an oil/brake/light, etc. to be displayed on a control panel of the automobile among information of the automobile constructional portion 350. The CANIF 334 outputs such information to the server 338.

The plug-in device IF 336 outputs information such as the kind of device connected to the plug-in device IF 336 by the user, for example, to the server 338.

The display/input apparatus 332 displays information inputted from the server 338, for example, and shows this information to the user. The display/input apparatus 332 also outputs information showing the kind of display/input apparatus 332, for example, to the server 338.

The display/input apparatus 332 includes an LCD display device, a touch panel, etc., and receives and outputs the operation of the user to the server 338.

The display/input apparatus 332 receives information from the server 338 and displays the information to the user.

FIG. 4 shows the hardware configuration of the server 338 (information using apparatus 24, and information collection/modification/distribution apparatus 4) of FIG. 3.

As shown in FIG. 4, the server 338 includes a computer main body 10 including an arithmetic apparatus (CPU) 102, a memory 104, a bus IF 106, etc., a communication interface (communication IF) 12 for transferring data between the communication interface and a wire communication apparatus or a wireless communication apparatus, a memory apparatus 14 such as an HDD/FDD/CD-ROM apparatus, etc., a display/input apparatus 16, etc.

The server 338 includes elements common to a general computer, and such a configuration is basically common to the information using apparatus 24 and the information collection/modification/distribution apparatus 4 except that performance, scale, etc. are different.

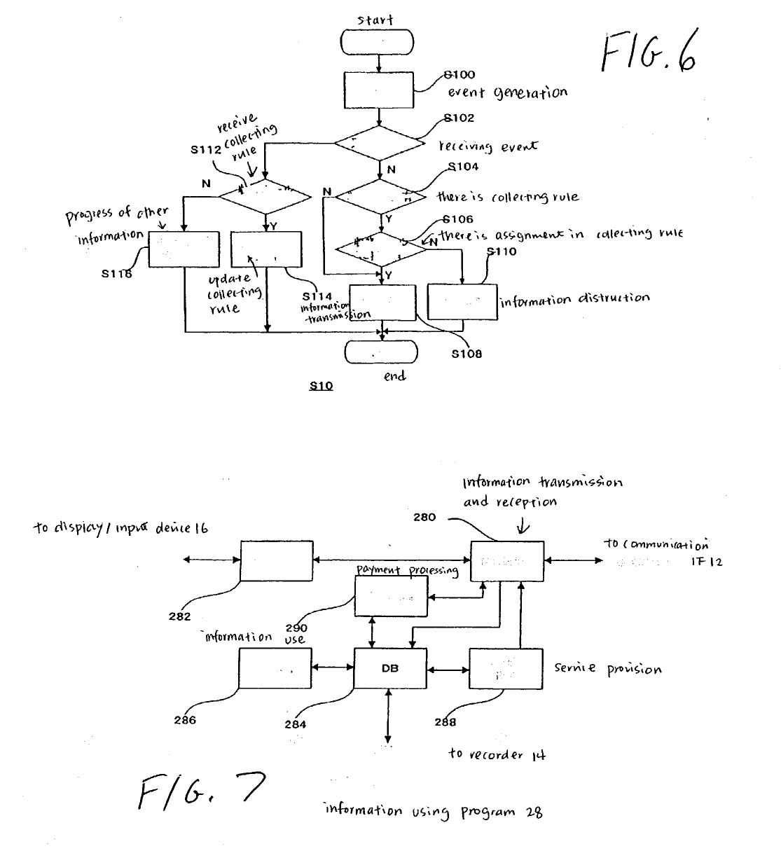

FIG. 5 shows the configuration of an information provision/utilization program 36 executed by the server 338 (FIGS. 3 and 5).

As shown in FIG. 5, the information provision/utilization program 36 includes a control section 360, an information collecting section 362, an information transmission/reception section 364, a collecting rule memory section 366 and a service utilizing section 368.

The information provision/utilization program 36 is supplied to the server 338 using apparatus 24 through a recording medium 140 or a network, and is loaded into a memory 104 and is executed.

Information is collected by these elements from each car mounted system constructional element 320, and is transmitted to the information collection/modification/distribution apparatus 4.

The information provision/utilization program 36 is supplied to the user through the car mounted server system constructional elements 320 by receiving a service provided by the information using apparatus 24 (information collection/modification/distribution apparatus 4).

In the information provision/utilization program 36, the control section 360 transmits and receives information through a bus 322 disposed between the control section 360 and the car mounted server system constructional elements 320.

As described later with reference to FIG. 8, the information collecting section 362 gets access to each of the car mounted server system constructional elements 320 through the information collecting section 362 in accordance with a collecting rule (rule base) supplied from the information collection/modification/distribution apparatus 4 and stored in the collecting rule memory section 366. The information collecting section 362 then collects information to be provided to the information collection/modification/distribution apparatus 4, and outputs this information to the information transmission/reception section 364. In the collecting rule, a collected information item, a collecting time, a collecting period, etc. can be changed for every information user in accordance with the request of an information user.

The information transmission/reception section 364 transmits and receives information between the information using apparatus 24 and the information collection/modification/distribution apparatus 4 through the communication IF 12 and the wireless apparatus 340.

The information transmission/reception section 364 transmits information collected by the information collecting section 362 to the information collection/modification/distribution apparatus 4, and receives the information of a service provided by the information using apparatus 24 (information collection/modification/distribution apparatus 4), and outputs this information to the service utilizing section 368.

The information transmission/reception section 364 outputs the operation of a user inputted from the display apparatus 332 (display/input apparatus 16; FIG. 4) to the information using apparatus 24 and the information collection/modification/distribution apparatus 4.

The service utilizing section 368, for example, functions as a browser and receives the information of a service inputted from the information transmission/reception section 364 and displays this information on the display apparatus 332, etc. through the control section 360. Thus, the service utilizing section 368 supplies the service received from the information using apparatus 24 (information collection/modification/distribution apparatus 4) when utilized by the user.

The operations of the information providing apparatus 30 and the information provision/utilization program 36 (FIGS. 3 to 5) will next be explained.

FIG. 6 shows the operation (S10) of the information providing apparatus 30 (information provision/utilization program 36; FIG. 5) of FIG. 3, for example, at an event generating time.

As shown in FIG. 6, in step 100 (S100), the control section 360 (FIG. 5) of the information provision/utilization program 36 detects the generation of an event in one of the car mounted server system constructional elements 320 (FIG. 3), and the information collecting section 362 collects information of the detected event.

Otherwise, in step S100, the information transmission/reception section 364 detects the generation of the receiving event from the information using apparatus 24 or the information collection/modification/distribution apparatus 4.

In step 102 (S102), when the event detected in step S100 is a receiving event, the information provision/utilization program 36 proceeds to step S112. Otherwise, the information provision/utilization program 36 proceeds to step S104.

When a collecting rule is stored in the collecting rule memory section 366 in step 104 (S104), the information provision/utilization program 36 proceeds to step S106. Otherwise, the information provision/utilization program 36 proceeds to step S108.

In step 106 (S106), the information collecting section 362 determines whether or not the information collected in step S100 is assigned by the collecting rule.

When the, collected information is assigned by the collecting rule, the information provision/utilization program 36 proceeds to step S108. Otherwise, the information provision/utilization program 36 proceeds to step S110.

In step 108 (S108), the information collecting section 362 transmits the collected information to the information collection/modification/distribution apparatus 4.

In step 110 (S110), the information collecting section 362 destroys the collected information.

In step 112 (S112), the information transmission/reception section 364 determines whether or not the received information is the collecting rule.

When the received information is the collecting rule, the information provision/utilization program 36 proceeds to step S114. Otherwise, the information provision/utilization program 36 proceeds to step S116.

In step 114 (S114), the information transmission/reception section 364 updates the collecting rule stored in the collecting rule memory section 366.

In step 116 (S116), the information provision/utilization program 36 performs processing (e.g., processing for utilizing a service provided by the information using apparatus 24 in the service utilizing section 368) of other information.

The construction of the information using apparatus 24 will next be explained.

FIG. 7 shows the configuration of an information using program 28 executed by the information using apparatus 24 of FIG. 1.

As shown in FIG. 7, the information using program 28 includes an information transmission/reception section 280, a user interface section (UI section) 282, a database section (DB) 284, an information processing section 286 and a service providing section 288.

As with the information provision/utilization program 36 (FIG. 5), the information using program 28 is supplied to the information using apparatus 24 through the recording medium 140, for example. and is loaded into the memory 104 and is executed.

The information transmission/reception section 280 transmits and receives information through the Internet 22 and the mobile communication system 3 between the information providing apparatus 30 and the information using apparatus 24.

The information transmission/reception section 280 transmits information showing the operation of a user of the information using apparatus 24 inputted from the UI section 282 to the information collection/modification/distribution apparatus 4, and outputs information such as a response, etc. from the information collection/modification/distribution or its apparatus 4 to the UT section 282.

The information transmission/reception section 280 transmits and receives information with respect to charges made between a payment processing section 290 and the information collection/modification/distribution apparatus 4.

The information transmission/reception section 280 outputs information of the information providing apparatus 30 received from the information collection/modification/distribution apparatus 4 to the DB 284.

The information transmission/reception section 280 transmits and receives information required to provide a service to the information providing apparatus 30 between the service providing section 288 and the information providing apparatus 30.

The UI section 282 receives information such as subscription registration, an information collecting request, a distributing request, etc. from the information collection/modification/distribution apparatus 4 inputted by the user of the information using apparatus 24 to the display/input apparatus 16 (FIG. 4), and outputs this information to the information transmission/reception section 280.

The UI section 282 displays various kinds of responses, etc. returned from the information collection/modification/distribution apparatus 4 in the display/input apparatus 16.

The DB 284 stores and manages information of the information providing apparatus 30 sent from the information collection/modification/distribution apparatus 4, and supplies this information in utilization of the service providing section 288 and an information modifying section 286.

The information using section 286 generates information to use the information stored to the DB 284 and collected from the information providing apparatus 30.

For example, software for analyzing information is used as the information using section 286 to form a strategy plan of an enterprise or a marketing plan by the information using apparatus 24, and software for statistical processing is used to analyze customers of the enterprise.

The service providing section 288 provides a service such as an advertisement, promotion, etc. to the information providing apparatus 30.

Otherwise, software for providing a point exchangeable for a premium, money, or goods/services as compensation for the information provision is used by the service providing section 288.

Otherwise, software for performing the promotion of new goods and a new service narrowed in the segment of an object person is also used by the service providing section 288.

References such as a geographical reference (area, the scale of a city, etc.), a population statistical reference (age, gender, occupation, income, school career, etc.), a mental reference (attitude, motive, etc.), a sociological reference (conformity group (political party, association, circle, etc.), life style, the type of a user, use ratio, brand, the degree of loyalty, etc.) and a benefit reference (economical efficiency, quality, service, etc.) are used to narrow the segment.

The payment processing section 290 performs payment processing in accordance with charges from the information collection/modification/distribution apparatus 4.

FIG. 8 shows the configuration of an information collection/modification/distribution program 40 executed by the information collection/modification/distribution apparatus 4 of FIG. 1.

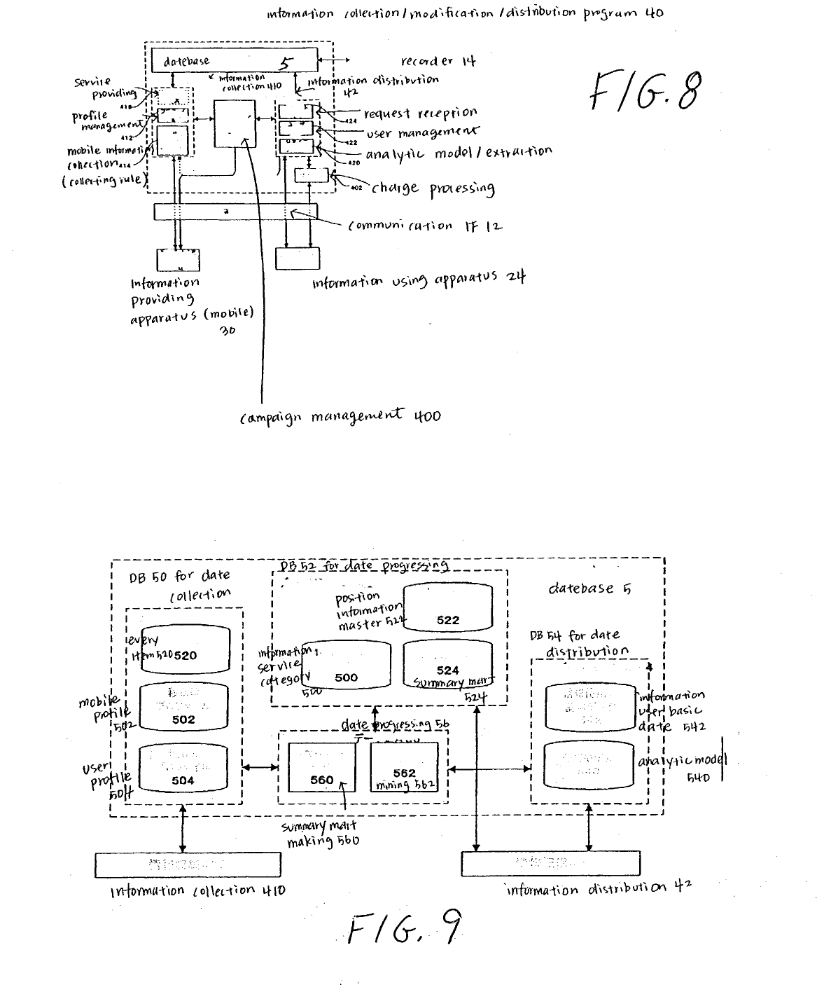

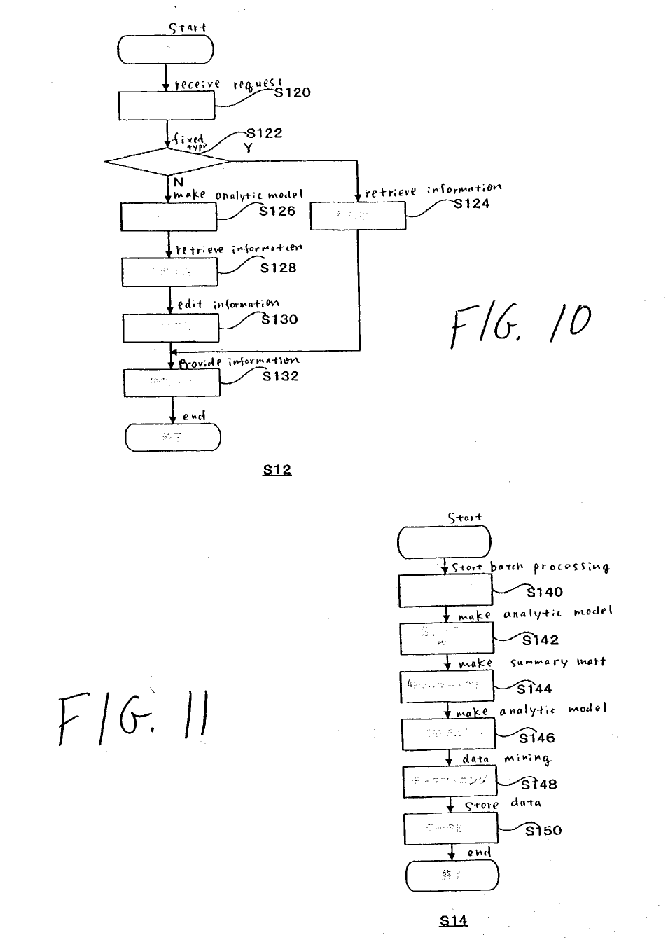

FIG. 9 shows the configuration of the database (DB) 5 of FIG. 8.

As shown in FIG. 8, the information collection/modification/distribution program 40 includes a campaign managing section 400, an accounting processing section 402, an information collecting section 410, an information distributing section 42 and the DB 5.

The information collecting section 410 includes a profile managing section 412 and a mobile information collecting section 414.

The information distributing section 42 includes an analytic model/extracting section 420, a user managing section 422 and a request receiving section 424.

As shown in FIG. 9, the DB 5 includes a DB 50 for collecting data, a DB 52 for processing data, a DB 54 for distributing data, and a data processing section 56.

The DB 50 for collecting data includes an itemized DB 520, a mobile profile DB 502 and a user profile 504.

The DB 52 for processing data includes an information service category DB 500, a position information master DB 522 and a summary mart DB 524.

The DB 54 for distributing data includes an analytic model DB 540 and an information user basic DB 542.

The data processing section 56 includes a summary mart forming section 560 and a mining section 562.

As with the information provision/utilization program 36 and the information using program 28, the information collection/modification/distribution program 40 is supplied to the information collection/modification/distribution apparatus 4 through the recording medium 140 (FIG. 4), etc., and is loaded in the memory 104 and is executed.

In the information collection/modification/distribution program 40, information is collected from the information providing apparatus 30 by these elements, and is modified and distributed to the information using apparatus 24.

The information collection/modification/distribution program 40 effects the charges of the distributed information.

For example, the campaign managing section 400 executes a campaign for accelerating registration to the information collection/modification/distribution apparatus 4 and the provision of information to the user of the information providing apparatus 30 when no information of quantity and quality matching the requirement of the user of the information using apparatus 24 is obtained, or when the user of the information using apparatus 24 wishes information to be limited to a time period, etc. The campaign managing section 400 then performs management during this execution.

In the campaign managed by the campaign managing section 400, there is a calling-out of the registration and the information provision to the user of the information providing apparatus 30 possibly having information desired by the user of the information using apparatus 24, the provision of a premium and money in the registration, the giving of a point exchangeable for goods and services, etc.

The campaign is basically performed with respect to a group judged as an object of the information collection using the campaign by segmentation among the information providing apparatus 30 registered in the information collection/modification/distribution apparatus 4.

The provision of a premium, money, a point, etc. is considered to be compensation for the user of the information providing apparatus 30 providing the information in accordance with the campaign.

The accounting processing section 402 performs accounting processing with respect to the information using apparatus 24 distributing the information to obtain the compensation for the information distribution.

In the information collecting section 410, the mobile information collecting section 414 collects information (user profile) with respect to the user of the information providing apparatus 30, and information (mobile profile) of the information providing apparatus 30 from the information providing apparatus 30. The mobile information collecting section 414 then respectively stores such information in the user profile 504 and the mobile profile DB 502, and manages this information.

The mobile information collecting section 414 stores information collected in real time from each information providing apparatus 30 to the itemized DB 520 by holding links with the user profile and the mobile profile stored and managed in the user profile DB 504 and the mobile profile DB 502.

The user profile stored and managed in the user profile DB 504 by the mobile information collecting section 414 includes information showing age, gender, address, number of years of driving experience, occupation, interests, preferences, etc. of the user of the information providing apparatus 30.

The mobile profile stored and managed in the mobile profile DB 502 by the mobile information collecting section 414 includes model, date of manufacture, number of years used, past repair record/collision, etc.

The information stored and managed in the itemized DB 520 in the mobile information collecting section 414 includes information as to the position of the information providing apparatus 30 detected by the GPS application apparatus 326, information (driving speed, oil and brake and light condition) obtained through the CANIF 334, etc., an operation (which radio station is selected, and which CD is being played) performed by the user with respect to the information providing apparatus 30, and the weather detected by a sensor (not illustrated in FIG. 3) connected to the information providing apparatus 30, etc.

The mobile information collecting section 414 classifies the collected information according to an event such as a collision, a failure, a change in weather, the passage of a specific place, etc., or classifies the collected information into the categories of an area, a time period, etc. The mobile information collecting section 414 then stores the classified information in the itemized DB 520 and manages this classified information correspondingly to the menu of an information service with respect to the information using apparatus 24.

The real time information collected by the mobile information collecting section 414 is stored in the Itemized DB 520 and is managed in a classified state without being directly stored and managed in a state in which no real time information corresponds to the menu.

As shown by a solid line in FIG. 8, there is a case in which the collecting rule is generated with respect to the information providing apparatus 30. As shown by a dotted line in FIG. 8, there is also a case in which the mobile information collecting section 414 generates the collecting rule.

In the former case, as described later with reference to FIG. 8, the campaign managing section 400 generates the collecting rule in accordance with a menu within the information service category DB 500, and generates the collecting rule with respect to the mobile information collecting section 414 or the information collecting section 362 (FIG. 5) of the information provision/utilization program 36.

In the latter case, the mobile information collecting section 414 generates the collecting rule in accordance with the menu within the information service category DB 500, and generates the collecting rule with respect to the information collecting section 362 of the information provision/utilization program 36, or uses the collecting rule generated by the mobile information collecting section 414.

The collecting rule assigns which of the above information should be collected with respect to each information providing apparatus 30.

When the collecting rule is generated by the mobile information collecting section 414, the mobile information collecting section 414 collects information from each information providing apparatus 30 in accordance with this collecting rule.

The profile managing section 412 receives registration of the user of the information providing apparatus 30 providing information to the information collection/modification/distribution apparatus 4, etc., and performs management such as registration, deletion of registration, updates, etc. with respect to information stored in the mobile profile DB 502 and the user profile DB 504.

When the information collection/modification/distribution apparatus 4 provides a service to the information providing apparatus 30 instead of the information using apparatus 24, the information collecting section 410 further includes a service providing section 416 having a function similar to that of the service providing section 288 (FIG. 7) as shown by a dotted line in FIG. 8.

In the information distributing section 42, the request receiving section 424 receives an information distributing request from the information using apparatus 24, and outputs the information distributing request to the analytic model/extracting section 420.

The request receiving section 424 also transmits information inputted from the analytic model/extracting section 420 to the information using apparatus 24 and outputs the information distributing request in accordance with the information distributing request.

When there is no information desired by the user of the information using apparatus 24, the request receiving section 424 requires the campaign managing section 400 to execute a campaign.

In the information distributing request, an item of the distributed information, a distributing time, a distributing time period, a distributing destination, etc. desired by the user of the information using apparatus 24 are assigned. This information is assigned in accordance with a fixed type form or an unfixed type form arbitrarily chosen by the user.

When the user of the information using apparatus 24 assigns information intended to receive the distribution in accordance with an analytic model of the fixed type form, the analytic model/extracting section 420 retrieves each database included in the DB 52 for processing data (FIG. 9). The analytic model/extracting section 420 then obtains information assigned in the fixed type form, and outputs this information to the request receiving section 424.

In contrast to this, when the user assigns the information in the unfixed type form, the analytic model/extracting section 420 makes the analytic model in accordance with the form assigned by the user, and retrieves each database included in the DB 52 for processing data in accordance with this analytic model. The analytic model/extracting section 420 then obtains information as a distributing object, and outputs this information to the request receiving section 424.

The analytic model/extracting section 420 also makes the analytic model (query) referred in a request of the information distribution from the information using apparatus 24, or in forming a summary mart by the summary mart forming section 560, and stores this analytic model in the analytic model DB 540 (FIG. 9) and manages this analytic model.

The analytic model/extracting section 420 also refers to the analytic model stored and managed in the analytic model DB 540 when the same information distributing request is received from the information using apparatus 24, etc.

The analytic model includes information showing the driving speed of a movable body, the number of vehicles driving, moving characteristics of the movable body, the behavior of a user (driver) of the information providing apparatus 30 within the car (what the user is doing), etc.

The analytic model/extracting section 420 obtains information assigned by the fixed type form with respect to each database included in the DB 52 for processing data in accordance with the information distributing request inputted from the request receiving section 424, and outputs this information to the request receiving section 424.

Otherwise, as mentioned above, the analytic model/extracting section 420 retrieves each database included in the DB 52 for processing data by using a model extracted from the information assigned by the unfixed type form, and obtains information assigned by the user of the information using apparatus 24, and outputs this information to the request receiving section 424.

The user managing section 422 receives registration and deletion of the registration of the user of the information using apparatus 24 requiring the information collection/modification/distribution apparatus 4 to distribute information, and stores the information of the user of the information using apparatus 24 in the information user database DB 542 (FIG. 9), and performs management such as the registration, the registration deletion, updates, etc.

The data processing section 56 (FIG. 9) modifies information stored in the DB 50 for collecting data and the DB 52 for processing data by performing batch processing. For example, the batch processing can be started just after data is periodically collected, or is collected from an information provider.

In the data processing section 56, the summary mart forming section 560 performs summary mart processing with respect to the information stored and managed in each database within the DB 50 for collecting data (FIG. 9) with reference to the analytic model DB 540, and forms the summary mart in which the information is classified into a time period, an area, a service, etc. The summary mart forming section 560 then stores this summary mart in the summary mart DB 524, and manages the summary mart.

The summary mart is formed in accordance with a service category stored in and managed by the information service category DB 500.

The position information master DB 522 stores and manages position information for converting position data of the information providing apparatus 30 to information such as an area, a road, a specific place, etc.

The summary mart forming section 560 analyzes the position information with the passage of time of each information providing apparatus 30 stored in and managed by the itemized DB 520 with reference to the position information master DB 522, and forms a summary mart showing the activity of each information providing apparatus 30.

The summary mart forming section 560 classifies the attribute (model, the number of years of use of the car, etc.) of the information providing apparatus 30 stored in the mobile profile DB 502 into areas, and extracts the information stored in and managed by each database included in the DB 50 for collecting data according to area, and forms the summary mart according to area.

The mining section 562 gets access to the itemized DB 520, the mobile profile DB 502 and the user profile DB 504, and performs mining processing such as a cluster analysis, a trend analysis, etc. with respect to the information stored in and managed by these databases, and finds and detects characteristics and behaviors included in this information.

The mining section 562 also stores information obtained by the mining processing to the information service category DB 500, and manages this information.

The operation of the information collection/modification/distribution apparatus 4 (information collection/modification/distribution program 40 of FIGS. 8 and 9) will next be explained.

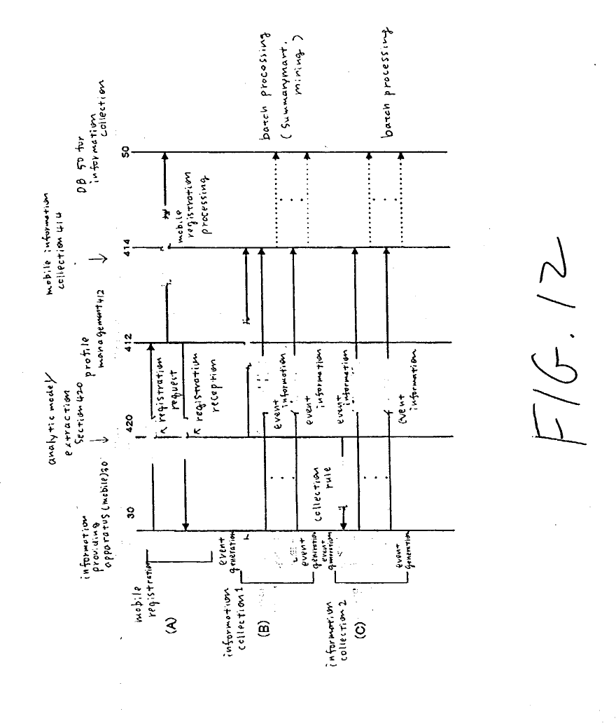

FIG. 10 shows the operation (S12) of the information distributing section 42 of the information collection/modification/distribution program 40 of FIG. 8.

As shown in FIG. 10, in step 120 (S120), the request receiving section 424 receives an information distributing request from the information using apparatus 24 (information using program 28 of FIG. 7), and outputs this information distributing request to the analytic model/extracting section 420.

In the late step 122 (S122), the analytic model/extracting section 420 determines whether or not information included in the received information distributing request is assigned by the fixed type form.

When the information is assigned by the fixed type form, the information collection/modification/distribution program 40 proceeds to step S124. Otherwise, the information collection/modification/distribution program 40 proceeds to step S126.

In step 124 (S124), the analytic model/extracting section 420 retrieves each database included in the DB 52 for processing data (FIG. 9), and collects the assigned information.

In step 126 (S126), the analytic model/extracting section 420 analyzes the assignment of information included in the unfixed type form, and forms a model.

In step 128 (S128), the analytic model/extracting section 420 retrieves each database (FIG. 9) included in the DB 52 for processing data by using the previously formed model.

In step 130 (S130), the analytic model/extracting section 420 edits information obtained by the retrieval in step S128.

In step 132 (S132), the analytic model/extracting section 420 outputs information obtained by the above processing to the request receiving section 424, and the request receiving section 424 distributes the information to the information using apparatus 24 requested the distribution of the information.

FIG. 11 shows batch processing (S14) of the data processing section 56 of the DB 5 of FIG. 9.

As shown in FIG. 11, in the late step 140 (S140), for example, the batch processing of the data processing section 56 (FIG. 9) is started just after data is periodically collected, or is collected from an information provider, etc.

In step 142 (S142), the summary mart forming section 560 forms an analytic model (for summary mart/fixed type analysis).

The fixed type analysis is formed to analyze information on the basis of the category of a fixed type information service provided to the information using apparatus 24.

In step 144 (S144), the summary mart forming section 560 forms a summary mart using the analytic model formed in step S142.

The summary mart forming section 560 extracts an area, a model, the age of a user (driver) of the information providing apparatus 30, etc. by using plural variables, and forms the fixed type summary mart of the late an average driving distance, for example, according to area, or to an accident ratio according to area, etc.

In step 146 (S146), the mining section 562 forms an analytic model (for mining/unfixed type analysis).

In step 148 (S148), the mining section 562 performs data mining processing.

The mining section 562 groups the user (driver) of the information providing apparatus 30 having similar information by a technique such as a cluster analysis, etc. using plural variables. For example, the mining section 562 analyzes which CD the driver of a specific age layer listens to, or what life style drivers who keep their automobile for a long period have.

In step 150 (S150), the summary mart forming section 560 and the mining section 562 store the results of the summary mart and the data mining obtained by the above processing in the summary mart DB 524 and the information service category DB 500, and manage these results.

The operation of the information collection/modification/distribution system 1 (FIGS. 1 to 11) will next be explained.

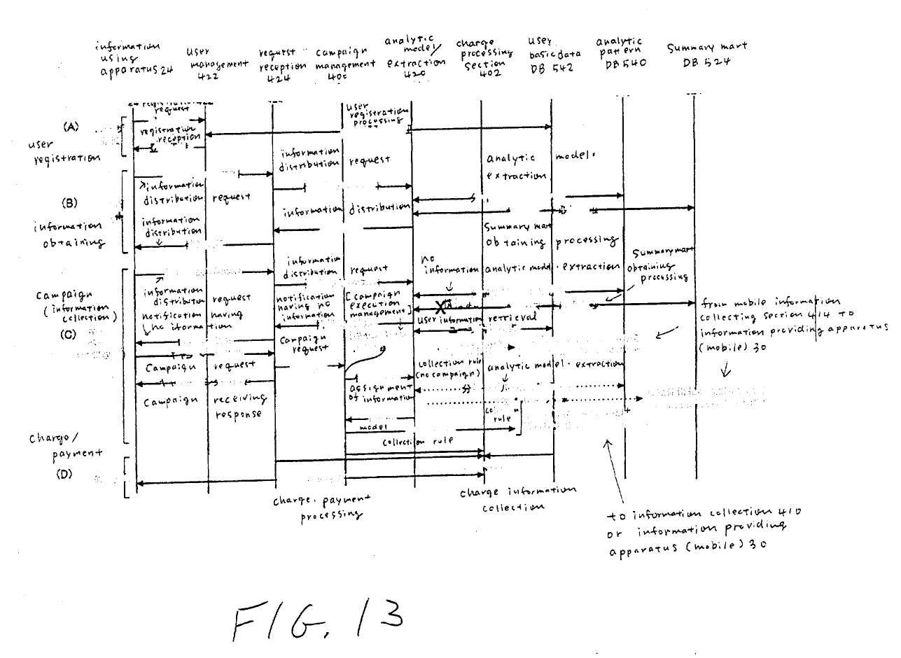

FIG. 12 shows a communication sequence between each information providing apparatus 30 shown in FIG. 1, etc. and the information collection/modification/distribution apparatus 4.

First, the operation of the information collection/modification/distribution system 1 will be explained by considering the communication sequence between the information providing apparatus 30 and the information collection/modification/distribution program 40.

As shown by adding (A) to FIG. 12, the user of the information providing apparatus 30 operates the display/input apparatus 332 of the car mounted server system constructional elements 320 (FIG. 3), and shows the contents of reception of the provision of a predetermined desirable service performed by the information using apparatus 24, and the contents of consent of the information provision of the information providing apparatus 30, and generates a registration request for the information collection/modification/distribution apparatus 4.

Upon receipt of the registration request from the user of the information providing apparatus 30, the profile managing section 412 of the information collection/modification/distribution program 40 (FIGS. 8 and 9) receives and registers this registration request in the DB 50 for collecting data.

Further, the profile managing section 412 answers the contents of the reception of the registration to the information providing apparatus 30.

As shown by adding (B) to FIG. 12, when the campaign managing section 400 (FIG. 8) transmits a collecting rule to the mobile information collecting section 414, the information providing apparatus 30 transmits information with respect to an event to the information collection/modification/distribution apparatus 4 every time the event is generated in the car mounted server system constructional elements 320.

The mobile information collecting section 414 extracts information shown by the collecting rule among the information sent from the information providing apparatus 30, and stores this information in each database included in the DB 50 for collecting data, and manages this information.

Software for performing a service similar to that of the service providing section 288 of the above information using apparatus 24 can be used as a service providing section 416. Further, software for providing a service such as one-stop shopping, etc. combined with a service performed as a business by the information using apparatus 24 can be used as the service providing section 416.

The data processing section 56 performs the batch processing with respect to the information stored in and managed by the DB 50 for collecting data as explained with reference to FIG. 11.

As shown by adding (C) in FIG. 12, when the collecting rule is transmitted to the information providing apparatus 30, the information providing apparatus 30 selects only information shown by the collecting rule stored in the collecting rule memory section 366 (FIG. 5), and transmits this information to the information collection/modification/distribution apparatus 4.

The mobile information collecting section 414 stores the information sent from the information providing apparatus 30 to each database included in the DB 50 for collecting data, and manages this information.

The data processing section 56 performs the batch processing with respect to the information stored in and managed by the DB 50 for collecting data as explained with reference to FIG. 11.

The operation of the information collection/modification/distribution system 1 will next be explained by considering a communication sequence between the information collection/modification/distribution apparatus 4 and the information using apparatus 24.

FIG. 13 shows the communication sequence between each information using apparatus 24 of FIG. 1, etc., and the information collection/modification/distribution apparatus 4.

As shown by adding (A) in FIG. 13, when the user of the information using apparatus 24 requests registration for utilizing the information collection/modification/distribution apparatus 4, the user managing section 422 (FIG. 8) receives this request, and registers the user of the information using apparatus 24 in the information user basic data DB 542 (FIG. 9).

Further, the user managing section 422 sends the reply of contents of the reception of the registration to the information using apparatus 24 that requested the registration.

As shown by adding (B) to FIG. 13, when the information using apparatus 24 outputs the request of information distribution to the information collection/modification/distribution apparatus 4, the request receiving section 424 transmits this request to the analytic model/extracting section 420 (FIG. 8).

The analytic model/extracting section 420 extracts a model of information with reference to the analytic model DB 540 (FIG. 9), and obtains a summary mart by using this model with reference to the summary mart DB 524, and transmits this summary mart to the information using apparatus 24 through the request receiving section 424.

As shown by adding (C) in FIG. 13, when the information using apparatus 24 outputs the request of information distribution to the information collection/modification/distribution apparatus 4, the request receiving section 424 transmits this request to the analytic model/extracting section 420 (FIG. 8).

The analytic model/extracting section 420 extracts a model of information with reference to the analytic model DB 540 (FIG. 9).

When the analytic model/extracting section 420 intends to obtain the summary mart with reference to the summary mart DB 524 by using this model, but cannot obtain this summary mart, the analytic model/extracting section 420 notifies the information using apparatus 24 through the request receiving section 424.

With respect to this notification, when the user of the information using apparatus 24 requests the execution of a campaign, the request receiving section 424 starts the campaign managing section 400 and sends the reply of contents of the reception of the campaign to the information using apparatus 24.

The campaign managing section 400 forms a plan of the campaign for obtaining information desired by the user of the information using apparatus 24, and manages this execution.

Further, the campaign managing section 400 assigns information to be collected by the campaign to the analytic model/extracting section 420.

The analytic model/extracting section 420 analyzes the information assigned by the campaign managing section 400, and extracts a model, and outputs this model to the campaign managing section 400.

The campaign managing section 400 forms a collecting rule in accordance with the menu of an information service with respect to the information using apparatus 24 within the information service category DB 500, and outputs this collecting rule to the information collecting section 410 or the information providing apparatus 30.

As shown by a dotted line by adding (C) and “*” in FIG. 13, when no user of the information using apparatus 24 desires the execution of the campaign, the mobile information collecting section 414 generates the collecting rule without starting the campaign managing section 400, and outputs this collecting rule to the information providing apparatus 30.

Further, as shown by adding (D) in FIG. 13, for example, the accounting processing section 402 performs accounting processing with respect to the information using apparatus 24 once per one month with reference to the number of information distributing request received by the request receiving section 424 and the assigned information, the contents of the campaign performed by the campaign managing section 400, and information of the user of the information using apparatus 24 stored in the information user basic DB 542, etc.

Application examples of the information collection/modification/distribution system 1 will next be explained.

Information is periodically distributed from the information collection/modification/distribution apparatus 4 to the information using apparatus 24, and the user of the information using apparatus 24 can practically use the distributed information.

The following examples can be used as examples of the practical use of the information periodically distributed in this way.

For example, a new car dealer or a used car dealer becomes the user of the information using apparatus 24, and receives the distribution of information such as driving distance, past repair record, a collision, etc. collected by the information collection/modification/distribution apparatus 4 from the information providing apparatus 30 stacked to the automobile of specific model and area, and practically uses this information as the basic data of sales activity and assessment of the car.

The information collection/modification/distribution apparatus 4 collects and/or distributes information at a time assigned by the information using apparatus 24, and the user of the information using apparatus 24 can practically use the distributed information.

For example, a traffic information service company becomes the user of the information using apparatus 24, and the user receives the distribution of information showing a moving mode of the information providing apparatus 30 calculated by the data processing section 56 among the information collected from the information providing apparatus 30 at the assigned time. The user then analyzes the traffic information (the amount of traffic, driving speed, etc.) of a specific area.

Further, for example, a music industry/broadcast station becomes the user of the information using apparatus 24, and receives the distribution of information such as a broadcast station selected by the user of the information providing apparatus 30, the title of a played CD, etc. from the information collection/modification/distribution apparatus 4 at, for example, a short time interval approximately considered as real time at a receiving time of the assigned distribution and a collecting time. This information is used as an information source of CD sales ranking/program selection.

The information for a limited time is distributed from the information collection/modification/distribution apparatus 4 to the information using apparatus 24, and the user of the information using apparatus 24 can practically use the distributed information.

The following examples can be used as examples of the practical use of the information distributed for a limited time in this way.

For example, a sales trader becomes the user of the information using apparatus 24, and receives the distribution of the amount of traffic of a specific area (near the planned site of a store opening) for a year, and information (profile) of the user of the information providing apparatus 30 from the information collection/modification/distribution apparatus 4, and practically uses these information in a marketing/store opening plan.

An automobile insurance company becomes the user of the information using apparatus 24, and receives the distribution of a profile of the user of the information providing apparatus 30 and past repair record, collisions and past failure record of an automobile stacking the information providing apparatus 30 from the information collection/modification/distribution apparatus 4, and practically uses this information as basic data of goods development of various kinds of automobile insurance and the calculation of insurance rates.

A load service provider becomes the user of the information using apparatus 24, and receives the profile of the user of the information providing apparatus 30, and the profile of an automobile such as past repair record, collisions and past failure record of the automobile stacking the information providing apparatus 30, the past record of a service received from this provider, the model and the style of the automobile, kind of parts, etc. from the information collection/modification/distribution apparatus 4. The load service provider can perform preparation for taking a more suitable measure in advance by practically using this information so that rapid service can be provided.

A trader for renting and leasing an automobile becomes the user of the information using apparatus 24, and receives the distribution of the profile of the user of the information providing apparatus 30, and past driving record of the automobile stacking the information providing apparatus 30 from the information collection/modification/distribution apparatus 4, and can more accurately set fees, maintenance and repayment period.

FIG. 1, etc. show cases in which the information collection/modification/distribution system 1 includes six information using apparatus 24, one information collection/modification/distribution apparatus 4 and seven information providing apparatus 30. However, these numbers are for exemplary purposes only, and may be arbitrarily set.

In the above explanation, the information using apparatus 24 or the information collection/modification/distribution apparatus 4 provides a service to the information providing apparatus 30 as a concrete example. However, the provision of a service of another apparatus (e.g., the apparatus of a hosting service trader; not illustrated in FIG. 1) connected to the Internet 22 instead of the information using apparatus 24 is the same as the provision of the service of the information using apparatus 24.

Furthermore, the information providing apparatus 30 in the present invention is not limited to a movable body, but may also be set into a computer, etc. connected to the Internet 22 through a wire line.

Anything capable of being transferred through a network among the respective constructional portions of the information provision/utilization program 36 (FIG. 5) can be suitably supplied from the information collection/modification/distribution apparatus 4, etc. to the server 338 (FIG. 3) as a mobile agent.

The model, the date of manufacture, past repair record/collision, etc. of the automobile may be managed by the information provision/utilization program 36 (FIG. 5) instead of the CANIF 334 (FIG. 3), and may be also provided to the information collection/modification/distribution apparatus 4.

Further, privacy of the user of the information providing apparatus 30 can be protected by excluding information which can specify the user of the information providing apparatus 30 and the information providing apparatus 30 from information collected in the information collection/modification/distribution apparatus 4 from each information providing apparatus 30.

As shown by adding (C) and ** with a dotted line in FIG. 13, the campaign managing section 400 can assign information to be collected by a campaign to the analytic model/extracting section 420, and the mobile information collecting section 414 may generate a collecting rule with reference to the information service category DB 500, and can also output this collecting rule to the information providing apparatus 30.

The application examples of the above information collection/modification/distribution system 1 are shown as examples, and do not show that the information collection/modification/distribution system 1 can be applied to only these examples.

The information collection/modification/distribution apparatus 4 may also provide information that changes according to area, space and time such as a speed, a driving path, and a change in weather, etc. to the information using apparatus 24 in real time.

In such a case, the data processing section 56 performs online processing of summary mart/mining using the generation of these events as a trigger from the information providing apparatus 30, and information obtained as a processing result is distributed to the information using apparatus 24.

In the information collection/modification/distribution apparatus 4, any well-known charging method can be used. For example, charges be made in the format of a distributing fee, and can be also made by the meter-rate system according to a time of use, and can be also made by a charge method not relating to the amount of use in the format of a subscription cost, etc.

As mentioned above, the embodiments of the present invention have been described in detail, but examples of the respective embodiments in accordance with the present invention will next be shown.

In an information distributing method for collecting and distributing information between one or more information distributors, one or more information users, and one or more information providers, each information distributor collects information from said information provider, and distributes said collected information to said information user. Each information user uses said distributed information, and provides a predetermined service to each information providers. Each information provider provides predetermined information to said information distributor, and utilizes said provided service.

In an information distributing method as noted above, said information distributor can provide said predetermined service instead of said information user.

In an information distributing method as noted above, said information distributor can charge the information user receiving said information.

In an information distributing method as noted above, the service provided by each of said information users can be free.

In an information distributing method as noted above, said information distributor can perform a campaign for accelerating the provision of the information to said information provider.

In an information distributing method as noted above, said information distributor can store said collected information, and can perform batch processing with respect to said stored information.

In an information distributing method as noted above, each information distributor can periodically distribute said information.

In an information distributing method as noted above, each information distributors can collect the information only for a predetermined period of time, and can distributed said collected information to each information user.

In an information distributing method as noted above, each information distributors can collect the information during a period of time, and can distributed said collected information during a period of time to each information user.

In an information distributing method as noted above, each information user can assign the distributed information to said information distributor, and each information distributors can modify said collected information in accordance with the assignment of said information user, and can distribute said modified information.

In an information distributing method as noted above, each information provider can include a predetermined apparatus, and each information distributor can collect information outputted from the apparatus included in said information provider.

In an information distributing method as noted above, each information provider can include a predetermined apparatus, and each information distributor can collect information showing an attribute of the apparatus included in said information provider, a state of the apparatus and an operation with respect to the apparatus.

In an information distributing method as noted above, each information provider can include an apparatus for detecting a position as said predetermined apparatus, and each information distributor can collect information showing the position of said information provider during a period of time, and can provide this information to each information user.

In an information distributing method as noted above, said information provider can be an automobile.

In an information distributing method as noted above, said information user can include a new car dealer or a used car dealer, and each information provider can include an automobile, and each information distributor can collect information showing a model, driving distance, past repair record and a driving area of said automobile, or a combination thereof and can provide said collected information to said new car dealer or used car dealer.

In an information utilizing method for utilizing information distributed by an information distributing method as noted above, said information user can be a traffic information service trader and can obtain traffic information by using said provided position information of each automobile over a period of time.

In an information utilizing method for utilizing information distributed by an information distributing method as noted above, said information distributor can further collect the attribute of a driver of said automobile, and can generate information showing a traffic amount according to area and the attribute of the driver of the passing automobile on the basis of said provided position information of each information provider over a period of time, and can provide the generated information to said information user, and said information user can include a retail trader, and said retail trader can utilize the provided information in at least a shop opening plan or marketing scheme.

In an information utilizing method for utilizing information distributed by an information distributing method as noted above, each information provider can include an automobile as said predetermined apparatus, and said information distributor can collect information showing the past record of repairs, accidents and fell years of each automobile, or a combination thereof, and can provide this information to an insurance company, and said information user can include the insurance company, and said insurance company can perform at least goods development or the calculation of an insurance rate using the provided information.

In an information utilizing method for utilizing information distributed by an information distributing method as noted above, each information provider can include a voice/screen image apparatus operated by a user, and each information distributor can collect information showing an operation of the user with respect to said voice/screen image apparatus, and can provide this information to said information user, and said information user can include a broadcast station or a music company, and said broadcast station or the music company can determine a preference of said user on the basis of said provided information showing the operation of each user with respect to the voice/screen image apparatus.

In an information utilizing method for utilizing information distributed by an information distributing method as noted above, each information provider can include an automobile as said predetermined apparatus, and said information distributor can collect information showing the past repair record, accidents and failures of each automobile, or a combination thereof, information showing an attribute and a state of the automobile including a make and model of said automobile, and information relating to a driver of said automobile, and can provide this information to said information user, and said information user can include a load service company, and can provide a more suitable rapid service using said information.

In an information utilizing method for utilizing information distributed by an information distributing method as noted above, each information provider can include an automobile as said predetermined apparatus, and said information distributor can provide a past driving record of each automobile to said information user, and said information user can include a rental lease trader of the automobile, and can more accurately perform fee setting, maintenance and a determination of a repayment period using said information.

An information distributing system connected to one or more information providing apparatus, one or more information distributing apparatus, and one or more information using apparatus, in which each information distributing apparatus has an information collector for collecting information from said information providing apparatus and an information distributor for distributing said collected information to said information using apparatus and each information using apparatus has an information user for using said distributed information and a service provider for providing a predetermined service to each information provider and each information provider has an information providing means for providing predetermined information to said information collector and a service utilizer for utilizing said provided service.

An information distributing apparatus connected to one or more information providing apparatus and one or more information using apparatus, in which each information using apparatus uses distributed information, and provides a predetermined service to each information providing apparatus, and each information providing apparatus provides predetermined information to an information collecting apparatus and utilizes said provided service; said information distributing apparatus comprising an information collector for collecting the information from said information providing apparatus and an information distributor for distributing said collected information to said information using apparatus.

In an information distributing apparatus according as noted above, said information distributing apparatus can further comprise a service provider for providing said predetermined service instead of said information using apparatus when said information using apparatus does not provide said predetermined service.

In an information distributing apparatus as noted above, said information distributing apparatus can further comprise accounting processor for generating a charge with respect to the information using apparatus distributed said information.

In an information distributing apparatus as noted above, said information distributing apparatus can further comprise a campaigner for accelerating the providing of information from said information providing apparatus.

In an information distributing apparatus as noted above, said information distributing apparatus can further comprise an information storer for storing said collected information and a batch processor for performing batch processing with respect to said stored information.

In an information distributing apparatus as noted above, each information using apparatus can assign an item of information to be distributed, a distributing time and collecting time and period to said information distributing apparatus, and said information distributing apparatus can further comprise an information modifier for modifying said collected information in accordance with said assignment and for distributing said modified information.

In an information distributing apparatus as noted above, each information using apparatus can assign an item of information to be distributed, a distributing time and collecting time and period to said information distributing apparatus, and said information providing apparatus can provide information in accordance with a collecting rule, and said information distributing apparatus can further comprise a collecting rule generator/transmitter for generating a rule for collecting said information to be distributed as said collecting rule, and for transmitting this rule to said information providing apparatus.

In an information distributing apparatus as noted above, each information using apparatus can assign an item of information to be distributed, a distributing time and collecting time and period to said information distributing apparatus, and said information distributing apparatus can further comprise a collecting rule generator for generating a collecting rule for collecting said information to be distributed, and said information collector can collect said information to be provided in accordance with said generated collecting rule.

And information providing apparatus connected to one or more information using apparatus and one or more information distributing apparatus, in which each information distributing apparatus collects information from said information providing apparatus and distributes said collected information to said information using apparatus, and each information using apparatus uses said distributed information, and said information using apparatus or said information distributing apparatus provides a predetermined service to each information providing apparatus, and said information providing apparatus comprises an information provider for providing predetermined information to an information collecting apparatus, and a service utilizer for utilizing said provided service.

In an information providing apparatus as noted above, each information using apparatus can assign information to be distributed to said information distributing apparatus, and said information distributing apparatus can generate a collecting rule for collecting said information to be distributed and can transmit the collecting rule to said information providing apparatus, and said information provider can receive the transmitted collecting rule and can provide the information in accordance with said received collecting rule.

In an information providing apparatus as noted above, said information provider can provide information showing the attribute of a predetermined apparatus, a state of said predetermined apparatus, an operation with respect to said predetermined apparatus and a past record of said predetermined operation, or a combination thereof.

An information using apparatus connected to one or more information providing apparatus and one or more information distributing apparatus, in which each information distributing apparatus collects information from said information providing apparatus and distributes said collected information to said information using apparatus, and each information providing apparatus provides predetermined information to an information collecting apparatus and utilizes said provided service, and said information using apparatus comprises an information user for using said distributed information, and a service provider for providing a predetermined service to each information providing apparatus.

In an information using apparatus as noted above, said information distributing apparatus can distribute information according to an assignment from said information using apparatus, and can further comprise an information assignor for assigning information to be distributed to said information distributing apparatus.

A program in an information distributing system connected to one or more information providing apparatus, one or more information distributing apparatus and one or more information using apparatus for respectively performing processing by a computer, in which the computer of each information distributing apparatus executes processing for collecting information from said information providing apparatus and processing for distributing said collected information to said information using apparatus; and the computer of each information using apparatus executes processing for using said distributed information and processing for providing a predetermined service to each information providing apparatus and the computer of said information providing apparatus executes processing for providing predetermined information to an information collector and processing for utilizing the service from said information using apparatus.

A program in an information distributing apparatus connected to one or more information providing apparatus and one or more information using apparatus, and performing processing by a computer, in which each information using apparatus uses distributed information, and provides a predetermined service to each information providing apparatus, and each information providing apparatus provides predetermined information to said information distributing apparatus, and utilizes said provided service and the computer executes processing for collecting information from said information providing apparatus and processing for distributing said collected information to said information using apparatus.

A program in an information providing apparatus connected to one or more information using apparatus and one or more information distributing apparatus, and performing processing by a computer, in which each information distributing apparatus collects information from said information providing apparatus and distributes said collected information to said information using apparatus, and each information using apparatus uses said distributed information and provides a predetermined service to each information providing apparatus, and the computer executes processing for providing predetermined information to said information distributing apparatus and processing for utilizing said provided service.

A program in an information using apparatus connected to one or more information providing apparatus and one or more information distributing apparatus, and performing processing by a computer, in which each information distributing apparatus collects information from said information providing apparatus and distributes said collected information to said information using apparatus, and each information providing apparatus provides predetermined information to said information distributing apparatus and the computer executes processing for utilizing the provided service and processing for using said distributed information and processing for providing a predetermined service to each information providing apparatus.

As explained above, in accordance with the method and the system for information distribution in accordance with the present invention, information relating to an apparatus such as an automobile, etc. used by many users can be collected and distributed to an enterprise associated with this apparatus. Furthermore, an information service can be provided to many users.

Still furthermore, in accordance with the method and the system for information distribution in accordance with the present invention, information useful for the enterprise can be obtained from many users even when the information service is provided at no charge.

What is claimed is:

1. A method of collecting and distributing information between one or more information distributors, one or more information users, and one or more information providers, the method comprising:
collecting information from said information provider and distributing said collected information to said information user, said collecting and distributing steps being performed by each information distributor;
using said distributed information and providing a predetermined service to each information provider; said using and providing steps being performed by each information user, and
providing predetermined information to said information distributor and utilizing said provided service; said information providing and utilizing steps being performed by each information provider.

2. The method of claim 1, wherein said information distributor provides said predetermined service.

3. The method of claim 1, further including generating a charge with respect to the information user distributing said information; said generating being performed by said information distributor.

4. The method of claim 1, wherein the service provided by each of said information users is provided at no charge.

5. The method of claim 1, further including accelerating the providing of information to said information provider; the accelerating step being performed by said information distributor.

6. The method of claim 1, further including storing said collected information and performing batch processing with respect to said stored information; said storing and processing being performed by said information distributor.

7. The method of claim 1, wherein each information distributor periodically distributes said information.

8. The method of claim 1, wherein each information distributor collects the information for a predetermined period of time, and distributes said collected information to each information user.

9. The method of claim 1, wherein each of said information distributors collects the information over a period of time, and distributes said collected information over a period of time to each information user.

10. The method of claim 1, further including assigning the distributed information to said information distributor, said assigning being performed by each information user, and
modifying said collected information in accordance with an assignment of each information user and distributing said modified information, said modifying and distributing being performed by each information distributor.

11. The method of claim 1, wherein each information provider includes a predetermined apparatus, and each information distributor collects information outputted from the apparatus included in said information provider.

12. The method of claim 11, wherein each information distributor collects information having an attribute of the apparatus included in said information provider, a state of the apparatus and an operation with respect to the apparatus.

13. The method of claim 11, wherein each information provider includes an apparatus for detecting a position as said predetermined apparatus, and each information distributor collects information showing the position of said information provider over a period of time, and provides this information to each information user.

14. The method of claim 13, wherein said information provider includes an automobile.

15. The method of claim 12, wherein said information user includes a new car dealer or a used car dealer,
each information provider includes an automobile, and
each information distributor collects information indicative of a model, a driving distance, a past repair record and a driving area of said automobile, or a combination thereof and provides said collected information to said new car dealer or the used car dealer.

16. A method of utilizing information distributed by the information distributing method of claim 13, wherein:
said information user is a traffic information service trader and obtains traffic information using position information of each provided automobile over a period of time.

17. A method of utilizing information distributed by the information distributing method of claim 13, wherein:
said information distributor further collects the attribute of a driver of said automobile, and generates information showing a traffic amount according to area and the attribute of the driver of the passing automobile on the basis of said provided position information of each information provider over a period of time, and provides the generated information to said information user, and
said information user includes a retail trader, and said retail trader utilizes the provided information in at least a shop opening plan or marketing plan.

18. A method of utilizing information distributed by the information distributing method of claim 14, wherein:
each information provider includes an automotive vehicle as said predetermined apparatus,
said information distributor collects information showing the past record of repairs, accidents and failures of each automotive vehicle, or a combination thereof, and provides this information to said information user, and
said information user includes an insurance company and said insurance company performs at least goods development or the calculation of insurance rates by using the provided information.

19. A method of utilizing information distributed by the information distributing method of claim 15, wherein:
each information provider includes an audio/screen image apparatus operated by a user,
each information distributor collects information showing an operation of the user with respect to said audio/screen image apparatus, and provides this information to said information user, and
said information user includes a broadcast station or a music company, and said broadcast station or the music company determines a preference of said user on the basis of said provided information showing the operation of each user with respect to the voice/screen image apparatus.

20. A method of utilizing information distributed by the information distributing method of claim 16, wherein:
each information provider includes an automotive vehicle as said predetermined apparatus,
said information distributor collects information showing the past record of repairs, accidents and failures of each automotive vehicle, or a combination thereof, information showing an attribute and a state of the automobile including a make and model of said automotive vehicle, and information relating to a driver of said automobile, and provides this information to said information user, and
said information user includes a load service company and provides an improved rapid service using said information.

21. A method of utilizing information distributed by the information distributing method of claim 11, wherein:
each information provider includes an automotive vehicle as said predetermined apparatus,
said information distributor provides a past driving record of each automotive vehicle to said information user, and
said information user includes a rental lease trader of an automotive vehicle and more accurately performs fee setting, maintenance and a decision as to a depreciation time period using said information.

22. An information distributing system comprising one or more information providing apparatus, one or more information distributing apparatus, and one or more information using apparatus, in which;
each information distributing apparatus including:
an information collector for collecting information from said information providing apparatus; and
an information distributor for distributing said collected information to said information using apparatus;
each information using apparatus including:
an information user for using said distributed information; and
a service provider for providing a predetermined service to each information provider; and
each information provider including:
a predetermined information provider for providing predetermined information to said information collecting means; and

23. An information distributing apparatus comprising one or more information providing apparatus, and one or more information using apparatus, in which each information using apparatus uses distributed information and is arranged to provide a predetermined service to each information providing apparatus, and each information providing apparatus is arranged to provide predetermined information to an information collecting apparatus and is arranged to utilize said provided service; further comprising:
an information collector for collecting information from said information providing apparatus; and
an information distributor for distributing said collected information to said information using apparatus.

24. The information distributing apparatus of claim 23, further comprising a service provider for providing said predetermined service in response to said information using apparatus not providing said predetermined service.

25. The information distributing apparatus of claim 23, further comprising an accounting processor for generating a charge with respect to the information using apparatus distributing said information.

26. The information distributing apparatus of claim 23, further comprising a campaigner for accelerating the providing of information from said information providing apparatus.

27. The information distributing apparatus of claim 23, further comprising an information storer for storing said collected information and a batch processor for performing batch processing with respect to said stored information.

28. The information distributing apparatus of claim 20, wherein each information using apparatus is arranged to assign an item of information to be distributed, time to receive distribution and a time and a time range of collection and time period to said information distributing apparatus, and
said information distributing apparatus further comprises an information modifier for modifying said collected information in accordance with said assignment and distributing said modified information.

29. The information distributing apparatus of claim 22, wherein each information using apparatus is arranged to assign an item of information to be distributed, time to receive distribution and a time and a time range of collection to said information distributing apparatus, and said information providing apparatus is arranged to provide information in accordance with a collecting rule, and
said information distributing apparatus further comprises a collecting rule generator and transmitter for generating a rule for collecting said information to be distributed as said collecting rule, and for transmitting this rule to said information providing apparatus.

30. The information distributing apparatus of claim 22, wherein each information using apparatus is arranged to assign: (a) an item of information to be distributed, (b) a time to receive distribution, and (c) a time range of collection and time of collection to said information distributing apparatus; and
further comprising a collecting rule generator for generating a collecting rule for collecting said information to be distributed, and
said information collector being arranged to collect said information to be distributed in accordance with said generated collecting rule.

31. An information providing apparatus connected to one or more information using apparatus and one or more information distributing apparatus, in which each information distributing apparatus being arranged to collect information from said information providing apparatus and distribute said collected information to said information using apparatus, and each information using apparatus being arranged to use said distributed information, and said information using apparatus or said information distributing apparatus being arranged to provide a predetermined service to each information providing apparatus,
said information providing apparatus comprising a predetermined information provider for providing predetermined information to an information collecting apparatus, and
a service utilizer for utilizing said provided service.

32. An information using apparatus connected to one or more information providing apparatus and one or more information distributing apparatus, in which each information distributing apparatus is arranged to collect information from said information providing apparatus and is arranged to distribute said collected information to said information using apparatus, and each information providing apparatus is arranged to provide predetermined information to an information collecting apparatus and utilizes said provided service,
said information using apparatus comprising an information user for using said distributed information, and
a service provider for providing a predetermined service to each information providing apparatus.

33. A storage device storing a program for use in an information distributing system connected to one or more information providing apparatus, one or more information distributing apparatus and one or more information using apparatus for respectively performing processing by computers, the program being arranged for causing the computer of each information distributing apparatus to execute the following processing steps:
collecting information from said information providing apparatus; and
distributing said collected information to said information using apparatus;
the program being arranged for causing the computer of each information using apparatus to execute the following processing steps:
using said distributed information; and
providing a predetermined service to each information providing apparatus; and
the program being arranged for causing the computer of said information providing apparatus to execute the following processing steps:
providing predetermined information to an information collector; and
utilizing the service from said information using apparatus.

34. A storage device storing a program for use in an information distributing apparatus connected to one or more information providing apparatus and one or more information using apparatus, and for causing processing by a computer, in which each information using apparatus uses distributed information, and provides a predetermined service to each information providing apparatus, and each information providing apparatus provides predetermined information to said information distributing apparatus, and utilizes said provided service;
the program causing the computer to execute the following processing steps:
collecting information from said information providing apparatus; and
distributing said collected information to said information using apparatus.

35. A storage device storing a program for use in an information providing apparatus connected to one or more information using apparatus and one or more information distributing apparatus, and for causing processing by a computer, in which each information distributing apparatus collects information from said information providing apparatus and distributes said collected information to said information using apparatus, and each information using apparatus uses said distributed information and provides a predetermined service to each information providing apparatus,
the program causing the computer to execute the following processing steps:
providing predetermined information to said information distributing apparatus; and
utilizing said provided service.

36. A storage device storing a program for use in an information using apparatus connected to one or more information providing apparatus and one or more information distributing apparatus, and performing for causing by a computer, in which each information distributing apparatus collects information from said information providing apparatus and distributes said collected information to said information using apparatus, and each information providing apparatus provides predetermined information to said information distributing apparatus and the computer executes the following processing steps:
utilizing a provided service;
using program causing the said distributed information; and
providing a predetermined service to each information providing apparatus.
